(19) United States
(12) Patent Application Publication
(10) Pub. No.: US 2014/0325275 A1
(43) Pub. Date: Oct. 30, 2014

(54) USING CUSTOMER COMPUTING SYSTEM TO TEST OTHER CUSTOMER COMPUTING SYSTEMS

(71) Applicant: HEWLETT-PACKARD DEVELOPMENT COMPANY, L.P., Houston, TX (US)

(72) Inventors: Sung Oh, Roseville, CA (US); Barry L. Goodwin, Roseville, CA (US); Niels E. Larsen, Roseville, CA (US)

(73) Assignee: Hewlett-Packard Development Company, L.P., Houston, TX (US)

(21) Appl. No.: 13/874,090

(22) Filed: Apr. 30, 2013

(51) Int. Cl. G06F 11/273

(52) U.S. Cl. CPC G06F 11/2736
USPC 714/25

(57) ABSTRACT

A factory computing system tests customer computing systems that one or more customers have ordered, prior to shipment of the customer computing systems to the one or more customers. In response to the factory computing system determining that a number of the customer computing systems being tested exceeds a threshold, the factory computing system uses a selected customer computing system of the customer computing systems to temporarily assist in testing other of the customer computing systems.

### BACKGROUND

Server computing devices have become the lifeblood of many organizations. For large organizations like business enterprises and governmental concerns, servers can be quite sophisticated and large pieces of hardware, involving many different components assembled in a dizzying number of particular configurations. As computing needs have grown, such organizations have purchased more and more servers, both to replace outdated existing servers and supplement existing servers with increased capacity.

### BRIEF DESCRIPTION OF THE DRAWINGS

FIG. 1 is a diagram depicting example logical operation of a dynamic factory test infrastructure resizing technique that temporarily employs customer computing systems to test other customer computing systems.

FIGS. 2, 3, and 4 are flowcharts of example methods used in conjunction with a dynamic factory test infrastructure resizing technique that temporarily employs customer computing systems to test other customer computing systems.

FIG. 5 is a diagram of an example factory test infrastructure that can be dynamically resized with temporarily added customer computing systems in accordance with techniques disclosed herein.

### DETAILED DESCRIPTION

As noted in the background section, many types of organizations employ server computing devices. Such servers are generally not purchased “off the shelf,” but rather are the subject of contracts with manufacturers who can customize servers to the organizations' needs and specifications in a relatively bespoke manner. When a customer places a customer order for a number of such computing systems, the computing systems are generally built at that time by appropriately installing and configuring the hardware and software thereof, and are also tested to ensure at least that the hardware is operating correctly and is not defective.

Many computing system manufacturers and customizers have a factory test infrastructure that they employ to configure and test computing systems prior to shipping them to customers in fulfillment of customer orders. A factory test infrastructure usually includes a factory computing system that is able to test a number of customer computing systems that have been communicatively connected to a common network. The factory computing system subjects the customer computing systems to various types of tests, and logs the results of these tests in a database.

A given factory computing system is able to concurrently test a predetermined maximum number of customer computing systems. If more than this number of customer computing systems have to be tested at the same time, to ensure desired factory throughput or to avoid a backlog of the number of customer computing systems that are awaiting testing prior to shipment, additional factory computing systems have to be installed within the factory test infrastructure. For example, if each factory computing system can test N customer computing systems and the desired number of customer computing systems that are to be concurrently tested is X>N, then the factory test infrastructure should include X/N factory computing systems, where X/N is rounded to the next highest integer.

However, installing a number of factory computing systems to ensure that a desired peak factory throughput is possible can result in an inefficient use of resources. For example, 90% of the time a factory test infrastructure may only have to test at most X<N customer computing systems concurrently, and just 10% of the time the test infrastructure may have to test at most X=K*N customer computing systems. This means that 90% of the time, K−1 factory computing systems remain unused, even though they continue to occupy factory floor space within the infrastructure, continue to use power and other resources, such as maintenance requirements, and so on—not to mention the initial procure and configuration costs thereof.

Compounding this problem is that factory computing systems generally have a limited useful lifetime, and have to be periodically replaced at least every few years to ensure that they are able to test customer computing systems that have the latest technology. Where K is a high value, this can result in a large number of factory computing systems only being actively used to test customer computing systems for just a few months or even weeks throughout their useful lifetimes before having to be replaced. Faced with this problem, a manufacturer may decide to permit a normally unacceptable backlog of customer computing systems that have to be tested during the 10% of the time that the a larger number of such systems have to be tested, rather than procuring and installing a more optimal number of factory computing systems.

Disclosed herein, by comparison, are techniques to alleviate these issues in a novel way that does not force a manufacturer having to decide between having a large backlog of customer computing systems that have to be tested and paying for the procurement and installation of a large number of factory computing systems that will remain unused the majority of the time. Specifically, customer computing systems are leveraged to test other customer computing systems. When more testing capacity is needed, and a given customer computing system has sufficiently passed testing successfully already and is capable of performing testing of other customer computing systems, the given system is temporarily employed in this capacity.

Therefore, a manufacturer does not have to purchase and install more than one factory computing system within the factory test infrastructure. As additional testing capacity is needed, customer computing systems can be temporarily borrowed to become part of the factory test infrastructure to temporarily increase the maximum number of customer computing systems that can be tested within the test infrastructure. This nearly cost-free dynamic resizing of the factory test infrastructure testing capacity is indeed limited in the extent to which it can temporarily increase the testing capacity by basically just the amount of factory space available in which customer computing systems can be concurrently connected to the network of the test infrastructure.

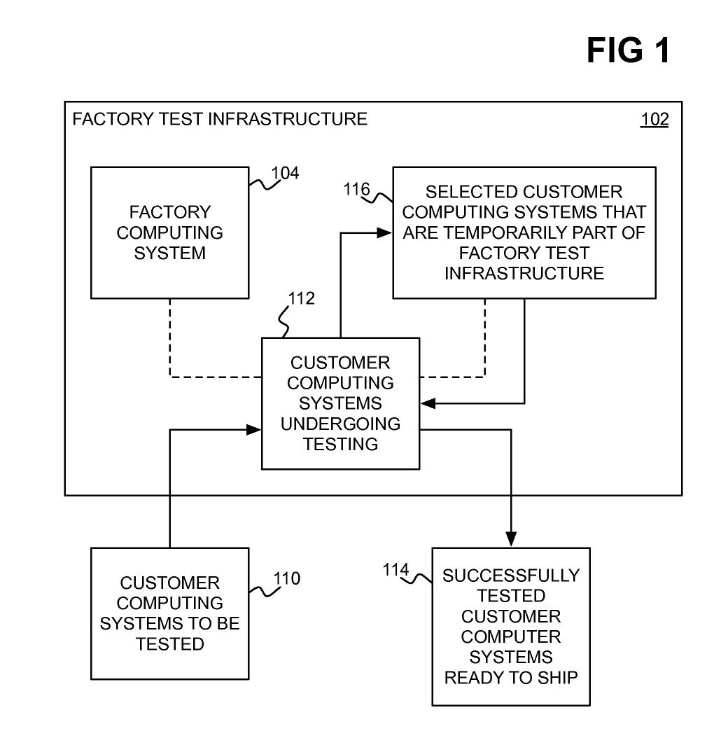

FIG. 1 shows example logical operation of this dynamic factory test infrastructure resizing technique. A factory test infrastructure 102 for testing customer computing systems 110, 112, 114, and 116 includes a factory computing system 104. The factory computing system 104 is not one of the customer computing systems 110, 112, 114, and 116, but rather is typically a permanent part of the factory test infrastructure 102, until the factory computing system 104 has to be repaired, replaced, and so on. There is at least one factory computing system 104, and in some implementations, there may just be one factory computing system 104. The factory computing system 104 can test at most N customer computing systems 110, 112, 114, and 116.

The customer computing systems 110, 112, 114, and 116 include customer computing systems 110 that are to be tested within the factory test infrastructure 102, but that have not yet been tested. The customer computing systems 110, 112, 114, and 116 include customer computing systems 112 that are currently undergoing testing within the factory test infrastructure 102, but that have not yet completed testing. The customer computing systems 110, 112, 114, and 116 include customer computing systems 114 that have successfully completed and have successfully passed testing within the factory test infrastructure 102, and are ready to ship to customers. The customer computing systems 110, 112, 114, and 116 include customer computing systems 116 that are currently undergoing testing within the factory test infrastructure 102, but that have been temporarily borrowed to temporarily become a part of the factory test infrastructure 102.

In general, a given customer computing system is first a customer computing system 110 that is waiting to be tested. Once this given customer computing system has entered the factory test infrastructure 102, it becomes a customer computing system 112 undergoing testing. Once the given customer computing system has successfully completed testing, it exits the factory test infrastructure 102 and becomes a customer computing system 114 that is ready to ship to a customer in satisfaction of a customer order. As described below, a customer computing system 112 undergoing testing can also temporarily become a customer computing system 116 that is part of the factory test infrastructure 102 itself. Such a customer computing system 116 subsequently resumes being testing within the factory test infrastructure 102 as a customer computing system 112 before exiting the factory test infrastructure 102 to become a customer computing system 114 that is ready to be shipped.

Where the number of the customer computing systems 112 undergoing testing within the factory test infrastructure 102 is less than N, then there may be no customer computing systems 110 waiting to be tested. The factory computing system 104 in this situation performs testing of the customer computing systems 112 by itself within the factory test infrastructure 102, and no additional customer computing systems 112 have to be borrowed to become part of the factory test infrastructure 102 as customer computing systems 116. However, the number of the customer computing systems 110 may exceed N, when a large number of customer orders have arrived, for instance, and which can lead to an undesirable backlog of the customer computing systems 110 waiting to be tested. This is because the factory computing system 104 is operating at full capacity in terms of the number of customer computing systems 112 that it can concurrently test (i.e., equal to N).

In this situation, the factory computing system 104 borrows a customer computing system 112 undergoing testing to temporarily become a selected customer computing system 116 that is temporarily part of the factory test infrastructure 102. As such, the customer computing system 116 is able to increase the number of customer computing systems 112 that can currently undergo testing within the factory test infrastructure 102. Where the customer computing system 116 can also test at most N customer computing systems 112, this means that the (temporary) addition of one customer computing system 116 to the factory test infrastructure results in the doubling of the capacity of the customer computing systems 112 currently undergoing testing from N to 2N. Each of the factory computing system 104 and the one customer computing system 116 is thus able to test N customer computing systems 112.

More customer computing systems 112 that are currently undergoing testing can be selected to join and temporarily become part of the factory test infrastructure 102 as needed. For example, when there is one factory computing system 104 and one customer computing system 116 that are each testing N customer computing systems 112, for a total of 2N customer computing systems 112 currently undergoing testing, if there is still a large backlog of customer computing systems 110 waiting to be tested, another customer computing system 112 can temporarily become a customer computing system 116 as part of the factory test infrastructure 112. If this second customer computing system 116 can also test up to N customer computing systems 112 concurrently, the capacity of the factory test infrastructure 102 is effectively increased to 3N customer computing systems 112 that can be tested at the same time. Third, fourth, fifth customer computing systems 116, and so on, can subsequently be selected from the customer computing systems 112 undergoing testing, too, to increase this capacity to 4N, 5N, 6N customer computing systems 112, and so on, that can be tested concurrently.

Generally, a customer computing system 116 that has become part of the factory test infrastructure 102 to test customer computing systems 112 remains part of the test infrastructure 102 for a period of time. After this period of time has elapsed, the customer computing system 116 is released from being part of the factory test infrastructure 102 to again become a customer computing system 112 undergoing testing, so that testing of this computing system 112 can be completed and so that the system 112 can exit the test infrastructure 102 and become a customer computing system 114 that is ready to ship. If after the release of a customer computing system 116 from the factory test infrastructure 102, a backlog in the customer computing systems 110 to be tested starts to build up again, a different customer computing system 112 undergoing testing can be selected to become a customer computing system 116. A given customer computing system 112 may be permitted to join the factory test infrastructure 102 as a customer computing system 116 at most one time, to avoid significant delay in the customer computing system 112 in question completing testing successfully and becoming a customer computing system 114 that is ready to be shipped to a customer.

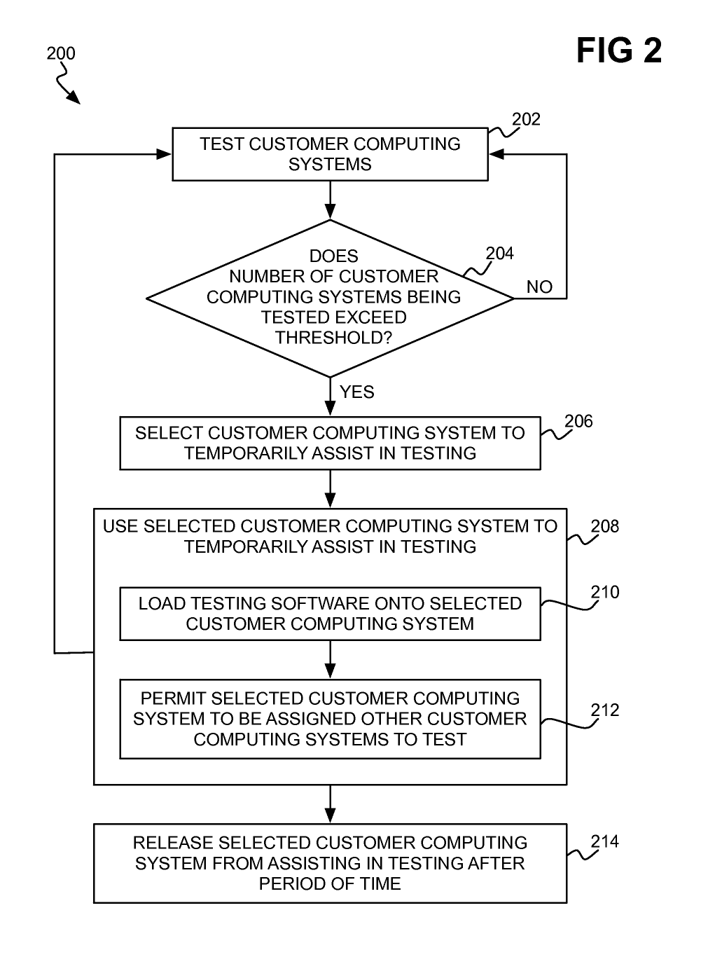

FIGS. 2, 3, and 4 show example methods 200, 300, and 400, respectively, according to the techniques disclosed herein. Various parts of the methods 200, 300, and 400 can be combined in different ways in implementations of these techniques. Each method 200, 300, and 400 can be implemented as a computer program stored on a non-transitory computer-readable data storage medium. The computer program can be executed by a processor of a computing device, like the factory computing system 104, to perform the method in question.

The example method 200 of FIG. 2 shows an overall approach for dynamically resizing the factory test infrastructure via customer computing systems temporarily joining the test infrastructure. A computing system of the factory test infrastructure, such as a factory computing system, tests customer computing systems that one or more customers have ordered (202), prior to shipment of these systems to the customers. In particular, a computing system of the factory test infrastructure is assigned to each new customer computing system that is to be tested. At the beginning, this computing system of the factory test infrastructure is the factory computing system itself. As one or more customer computing systems are temporarily added to the factory test infrastructure, they, too, may be assigned to perform testing.

It is noted that an order for a customer computing system can include the hardware that is to be installed therein, the software to be installed thereon, and a configuration of this hardware and/or software. A customer computing system is generally one or more computing devices, such as just one computing device, like a server computer. Testing of the customer computing systems can in some implementations including installing the hardware and/or software thereof, as well as configuring these computing systems, in addition to subjecting the systems to a battery of different tests to ensure that there are no inoperative parts, and so on.

The factory computing system has a maximum predetermined number of customer computing systems that it can concurrently test, which has been referred to as N above. As customer computing systems are to be tested, the factory computing system begins this testing immediately if it has the available capacity to do so. Furthermore, a threshold can be associated with the predetermined number of customer computing systems that the factory computing system can test. This threshold may be equal to this maximum number of customer computing systems that the factory computing system can test, or it may be some lower number of such systems.

The number of customer computing systems currently being tested within the factory test infrastructure is compared to the threshold (or a multiple thereof, as described later) to determine whether a customer computing system should be temporarily added to the factory test infrastructure, if available, to assist in testing. Having a threshold lower than the maximum predetermined number of customer computing systems can ensure that any delay in adding such a customer computing system to the factory test infrastructure does not delay testing being conducted within the factory test infrastructure. That is, while the customer computing system is being temporarily added to the factory test infrastructure, the factory computing system would still have capacity to perform testing until the temporarily added customer computing system is also able to perform testing.

If the number of customer computing systems does not exceed the threshold in question (204), then the method 200 is repeated at part 202. However, if the number of customer computing systems being tested exceeds the threshold (204), then the factory computing system selects one of the customer computing systems currently being tested to temporarily assist in this testing (206), by temporarily joining the factory test infrastructure. In the method 200, it is presumed that there is at least one customer computing system currently undergoing testing within the factory test infrastructure that can be selected to temporarily assist in testing.

The selected customer computing system is chosen such that it satisfies one or more different conditions. A first condition is that the selected customer computing system has a hardware configuration that is sufficient to perform testing. If a customer computing system has insufficient and/or not sufficiently powerful hardware resources, and/or is configured in a way that does not permit it to perform testing, then this computing system is not selected in part 206. For example, if testing is performed by running certain testing software, then if the customer computing system cannot run this software for whatever reason, it is not a candidate for being selected to temporarily join the factory test infrastructure.

A second condition is that the selected customer computing system has reached the proper stage in its own testing. First, for instance, if a customer computing system has already had customer software loaded thereon and/or a non-volatile storage device installed therein, then it may not be a candidate for selection. This ensures that there is not even a remote chance that remnants of the testing software to be loaded on the system will remain when the customer computing system is ultimately shipped to the customer that ordered the system. Second, the customer computing system should have itself successfully passed a predetermined portion of the testing. For example, the processor, memory, and networking hardware of the customer computing system should be operating properly before the customer computing system can itself be selected to test other customer computing systems.

A third condition is that the selected customer computing system is part of a customer order permitting partial shipment of ordered computing systems, as opposed to being part of a customer order that requires complete shipment of the ordered computing systems. A customer may order a number of computing systems. The customer may specify that as these computing systems are tested, they can be shipped (i.e., partial shipment), or that the computing systems should not be shipped until they have all successfully completed testing (i.e., complete shipment). In the latter case, it may not be desirable to select one of these computing systems to temporarily join the factory test infrastructure, to ensure that there is no possibility that shipment will be held up while the computing system in question is performing testing as part of the factory test infrastructure.

The factory computing system uses the selected customer computing system to temporarily assist in testing (other) customer computing systems as part of the factory test infrastructure (208). In effect, this means that available testing capacity of the factory test infrastructure is increased by the number of computing systems that the selected customer computing system can itself test. Using the selected customer computing system to temporarily assist in testing within the factory test infrastructure can include the following.

First, the factory computing system loads testing software onto the selected customer computing system (210). The testing software, when executed by a computing system, permits the computing system to run tests on other computing systems within the factory test infrastructure. The factory computing system thus can be considered to at least some effect to be cloning itself on the selected customer computing system with respect to such testing functionality, although the factory computing system itself may retain sole supervisory authority within the test infrastructure. Such supervisory authority can include adding and releasing customer computing systems to and from the factory test infrastructure, assigning which computing system (i.e., itself or one of the customer computing systems that has been temporarily added to the test infrastructure) is to test a newly received customer computing system, and so on.

The testing software may be installed within the volatile memory of the selected customer computing system, over a common network to which the factory computing system and the selected customer computing system are both communicatively connected. Loading the testing software into volatile memory as opposed to on a non-volatile storage device of the selected customer computing system can be desirable at least because the selected customer computing system may not have had its non-volatile storage device installed yet, as noted above. Furthermore, this ensures that when the selected customer computing system is powered down, no remnants of the testing software remains on the selected customer computing system.

Second, the factory computing system permits the selected customer computing system to be assigned other customer computing systems to test within the factory test infrastructure (212). Each customer computing system that has temporarily joined the factory test infrastructure can be tagged as being permitted to accept such assignment, or being prohibited from accepting such assignment. Therefore, flagging the selected customer computing system in question as being permitted to be assigned other customer computing systems to test permits the selected customer computing system to increase the available testing capacity of the factory test infrastructure.

After part 208 is performed, the method 200 can be repeated at 202. For instance, the factory computing system can assign other customer computing systems to the selected customer computing system that has just been added to the factory test infrastructure. Therefore, even if the factory computing system itself does not have available capacity to itself accept assignment for such testing, the factory test infrastructure as a whole can still have available capacity due to the temporarily added selected customer computing system.

It is noted that as the method 200 is repeated, more than one selected customer computing system can ultimately be added temporarily to the factory test infrastructure. For example, while a first selected customer computing system is temporarily assisting in testing, it, too, may reach maximum testing capacity, such that a second selected customer computing system may also be temporarily added to the factory test infrastructure, and so on. In one implementation, each customer computing system has the same predetermined maximum number of computing systems that it can concurrently test as the factory computing system does. As such, the number of customer computing systems may be compared to successive multiples of the threshold associated with this maximum number in part 204 as selected customer computing systems have temporarily joined (and remain temporarily a part of) the factory test infrastructure, to determine whether another customer computing system should be selected for temporary addition to the test infrastructure.

After some period of time, a selected customer computing system is released from the factory test infrastructure (214), such that it no longer performs testing within and is no longer considered a part of the test infrastructure. That is, the selected customer computing system is released so that it no longer temporarily assists in testing. This permits the selected customer computing system in question to resume being tested itself within the factory test infrastructure, such that ultimately it can be shipped to the customer in accordance with a customer order for the selected customer computing system. Example details regarding the conditions governing release of a selected customer computing system are presented later in the detailed description.

It is noted that the process described in relation to the example method 200 can be at least partially hidden from factory personnel responsible for overseeing the testing of customer computing systems. For instance, a selected customer computing system that is temporarily added to the factory test infrastructure may be indicated as simply being “in process,” without immediate indication that this computing system is temporarily assisting in testing other customer computing systems. Furthermore, the process can be performed without any intervention by such factory personnel. The selection in part 206, the loading of testing software in part 210, and so on, can be performed automatically, without manual interaction by the factory personnel. This is particularly the case where the customer computing systems and the factory computing system are communicatively connected to a common network, for instance.

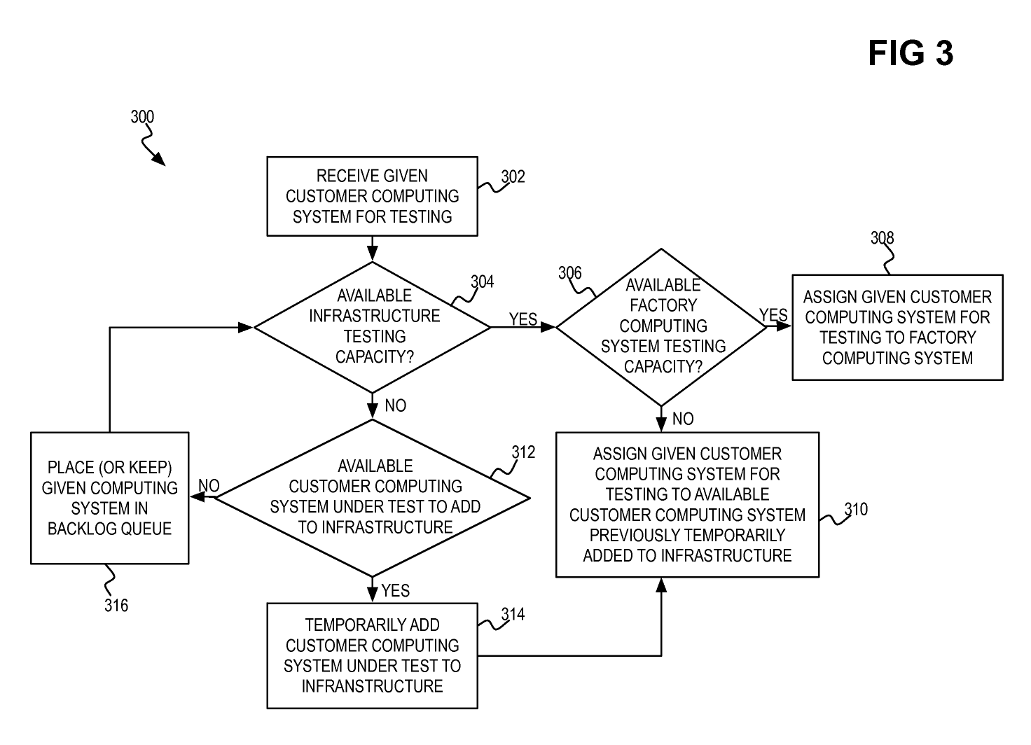

The example method 300 of FIG. 3 shows the process that the factory computing system performs when a customer computing system is to be tested. This is the case regardless of whether the factory computing system is solely performing testing within the factory test infrastructure, or if the factory computing system has already added one or more customer computing systems to the test infrastructure. The factory computing system is said to receive a given customer computing system (302).

The factory test infrastructure as a whole has a testing capacity. The factory test infrastructure's testing capacity is equal to the sum of the testing capacity of each computing system within the factory test infrastructure. For instance, if the factory computing system is the only computing system that can perform testing, then the factory test infrastructure's capacity is equal to the factory computing system's infrastructure. However, as customer computing systems are temporarily added to the factory test infrastructure, their testing capacities are added to the factory test infrastructure's testing capacity as a whole.

If there is available testing capacity within the factory test infrastructure to immediately begin testing of the given customer computing system (304), and in one implementation if the factory computing system itself has available testing capacity (306), then the factory computing system assigns itself to test the given customer computing system (308). It is noted that when no customer computing systems have been temporarily added to the factory test infrastructure, the test infrastructure having available testing capacity means that the factory computing system itself has available testing capacity. This is because the factory computing system is the only computing system within the infrastructure at that time.

If there is available testing capacity within the factory test infrastructure to immediately begin testing of the given customer computing system (304), but the factory computing system does not have available testing capacity (306), then the factory computing system assigns an available customer computing system previously added to the test infrastructure to test the given computing system (310). It is noted that when one or more customer computing systems have been temporarily added to the factory test infrastructure but the factory computing system itself does not have available testing capacity, the test infrastructure having available testing capacity means that at least one of these customer computing systems does have available testing capacity. Otherwise, there would be no available testing capacity within the factory test infrastructure as a whole.

If there is no available testing capacity within the factory test infrastructure to immediately begin testing of the given customer computing system (304), though, there may be a customer computing system currently being tested within the test infrastructure that is available to temporarily add to the infrastructure. In this case (312), the factory computing system temporarily adds the customer computing system in question to the factory test infrastructure (314), and assigns this customer computing system to test the given computing system (310). As such, the available testing capacity of the factory infrastructure as a whole is increased. It is noted that a customer computing system is currently being tested being available for temporarily joining the factory test infrastructure can mean such a system satisfies the conditions noted above with respect to part 206 of the method 200.

However, if there is no available testing capacity within the factory test infrastructure to immediately begin testing of the given customer computing system (304), and there are is no customer computing system currently being tested within the test infrastructure that is available to temporarily add to the infrastructure (312), then the available testing capacity of the infrastructure as a whole cannot be increased at this time. As such, testing of the given customer computing system cannot be immediately started, and instead the factory computing system places the given computing system in a backlog queue (316) to wait until there is testing capacity available within the factory test infrastructure. Therefore, the method 300 proceeds back to part 304.

Each time part 316 is subsequently reached for this given customer computing system when there is still no testing capacity available within the factory test infrastructure, the factory computing system keeps the given computing system in the backlog queue. At some point, however, testing capacity becomes available within the factory test infrastructure. For instance, testing of another customer computing system may have completed, such that testing of the given customer computing system can now begin. As another example, another customer computing system may have become available to temporarily join the factory test infrastructure, ultimately increasing the testing capacity of the test infrastructure. When such a customer computing system joins the factory test infrastructure and is ready to accept testing assignment, it can thus be assigned to test the given customer computing system.

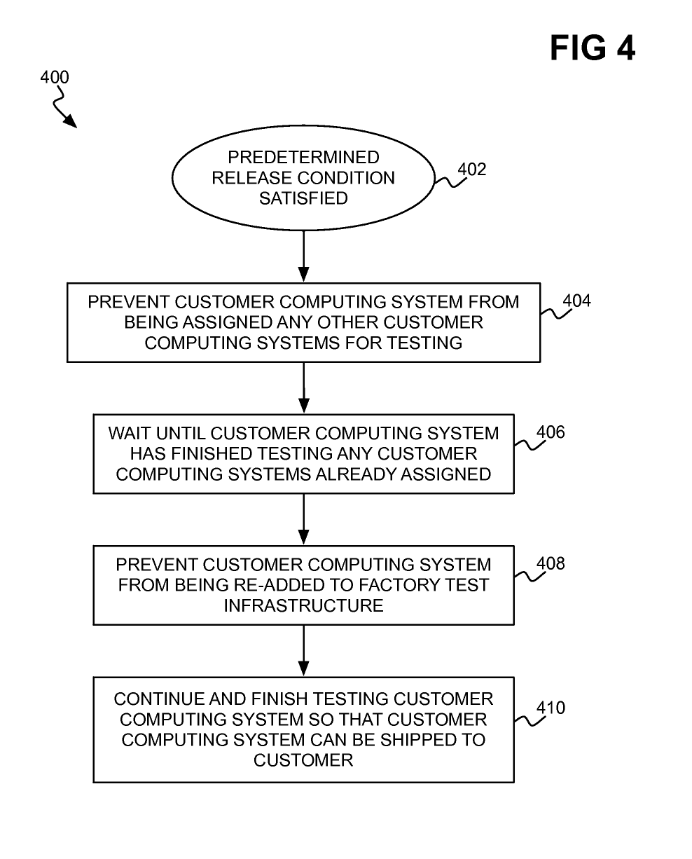

The example method 400 of FIG. 4 shows how a customer computing system that has been temporarily added to the factory test infrastructure can be subsequently released from the test infrastructure to continue being tested itself for ultimate shipment to a customer. When a customer computing system is added to the factory test infrastructure, the time at which it is so added is logged. Thereafter, a predetermined release condition is satisfied (402) that dictates that the customer computing system can be released from being part of the factory test infrastructure.

One such condition is that a predetermined length of time has elapsed since the customer computing system was temporarily added to the factory test infrastructure. This ensures that no customer computing system remains a part of the factory test infrastructure for too long, delaying ultimate shipment thereof to a customer, regardless of whether new customer orders for other customer computing systems continue to arrive. Another such condition is that the factory test infrastructure currently has excess available testing capacity. A customer computing system may have been added to the factory test infrastructure to accommodate a short-lived surge in customer orders. As such, when the customer computing systems of those orders have been tested and shipped, it may be desirable to release a customer computing system that is still part of the factory test infrastructure since it is now idle.

When such a predetermined release condition has been satisfied (402), the release process performed by the factory computing system for the customer computing system in question is as follows. The factory computing system prevents the customer computing system from being assigned any other customer computing systems for testing (404). That is, the factory computing system tags the customer computing system as being prohibited from being assigned any other customer computing systems to test. However, the computer computing system may still be currently testing other customer computing systems that were previously assigned to it. Therefore, the factory computing system waits from proceeding further in the method 400 until the customer computing system has finished testing these already assigned customer computing systems (406).

Thereafter, the factory computing system can prevent the customer computing system from being re-added to the factory test infrastructure later (408). This ensures that there is not a chance for the customer computing system being repeatedly added to the factory test infrastructure, such that its shipment to the customer that ordered the customer computing system is overly delayed. The factory computing system also causes testing of the customer computing system to continue and finish, so that the customer computing system can exit the factory test infrastructure and be shipped to this customer (410).

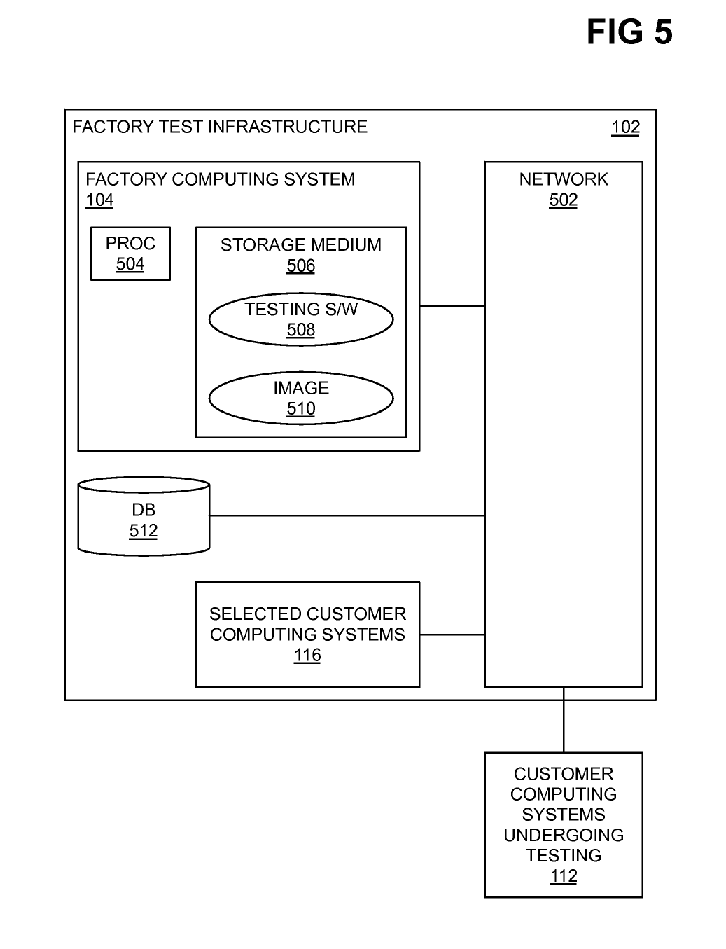

FIG. 5 shows an example of the factory test infrastructure 102 that can be dynamically resized in accordance with the techniques that have been described. The factory test infrastructure 102 includes the factory computing system 104 and a database 512 that are communicatively connected to a network 502, which can generally be a private network of the factory including the test infrastructure 102, and which may or may not be accessible outside the factory. The factory test infrastructure 102 also can temporarily include the selected customer computing systems 116 that have been temporarily added to the test infrastructure 102.

It is noted that the customer computing systems 110 and 114 of FIG. 1 are not depicted in FIG. 5. The customer computing systems 110 are not depicted in FIG. 5 because they have not been connected yet to the network 502 to undergo testing or potential assignment for being tested within the factory test infrastructure 102. The customer computing systems 114 are not depicted in FIG. 5 because they have already been disconnected from the network 502 since the customer computing systems 114 have completed testing and are ready to be shipped to customers.

The factory computing system 104 is depicted in FIG. 5 as including a processor and a computer-readable data storage medium 506, such as volatile memory, a non-volatile storage device, and so on. The factory computing system 104 can be implemented as one computing device, such as a server computer. The factory computing system 104 typically includes other components in addition to those depicted in FIG. 5, such as network adapters, integrated circuits other than the processor, and so on.

The storage medium 506 stores testing software 508 that the processor 504 executes for the factory computing system 104 to test the customer computing systems 112. The testing software 508 thus permits the factory computing system 104 to perform the methods 200, 300, and 400 that have been described. The storage medium 506 also stores a testing software image 510. The testing software image 510 is at least a subset of the testing software 508, and is what the factory computing system 104 copies (i.e., replicates) to each selected customer computing system 116 for the selected customer computing systems 116 to perform testing themselves on other customer computing systems 112. The supervisory aspects of the testing software 508 are not part of this image 510. These supervisory aspects include assigning customer computing systems 112 among the factory computing system 104 and the selected customer computing systems 116 for testing, adding to the factory test infrastructure 102 and releasing (i.e., removing) therefrom the selected customer computing systems 116, and so on.

The database 512 stores test results for the customer computing systems 112 currently undergoing testing within the factory test infrastructure 102. The factory computing system 104 and the selected customer computing systems 116 thus log test results of the customer computing systems 112 they are testing to the database 512. If a customer computing system 112 fails testing, factory and other personnel can therefore examine and review the database 512 to determine what caused the failure.

We claim:

1. A method comprising:
testing, by a factory computing system, a plurality of customer computing systems that one or more customers have ordered, prior to shipment of the customer computing systems to the one or more customers; and
in response to the factory computing system determining that a number of the customer computing systems being tested exceeds a threshold associated with a predetermined number of computing systems that the factory computing system can test concurrently,
using, by the factory computing system, a selected customer computing system of the customer computing systems to temporarily assist in testing other of the customer computing systems.

2. The method of claim 1, further comprising, in response to the factory computing system determining that the number of the customer computing system being tested exceeds the threshold,
selecting the selected customer computing system as one of the customer computing systems that at least:
has successfully passed a predetermined portion of testing by the factory computing system already, and
has a hardware configuration sufficient to test other of the customer computing systems.

3. The method of claim 2, wherein selecting the selected customer computing system further comprises selecting the one of the customer computing systems that also is part of a customer order permitting partial shipment of ordered computing systems and is not part of a customer order requiring complete shipment of the ordered computing systems.

4. The method of claim 2, wherein selecting the selected customer computing system further comprises selecting the one of the customer computing systems that also has not yet had customer software loaded onto a non-volatile storage device thereof.

5. The method of claim 1, wherein using the selected customer computing system comprises:
loading, by the factory computing system, testing software used by the factory computing system within volatile memory of the selected customer computing system, such that when the selected customer computing system is powered down the testing software does not remain thereon; and
assigning, by the factory computing system, the other of the customer computing systems to the selected customer computing system for testing by the selected customer computing system, such the selected customer computing system tests the other of the customer computing systems for the factory computing system by running the testing software loaded thereon.

6. The method of claim 1, further comprising, after a period of time:
releasing, by the factory computing system, the selected customer computing system from assisting in testing the other of the customer computing systems so that the selected customer computing system no longer temporarily assists in testing and so that the selected customer computing system can ultimately be shipped to a customer in accordance with an order therefrom.

7. The method of claim 1, wherein the selected customer computing system is used by the factory computing system to temporarily assist in testing without any intervention by factory personnel supervising testing of the customer computing systems.

8. The method of claim 1, wherein the selected customer computing system is a first selected customer computing system, and the method further comprises, while the selected customer computing system is still temporarily assisting in testing the other of the customer computing systems:
in response to the factory computing system determining that the number of the customer computing systems being tested exceeds twice the threshold,
using, by the factory computing system, a second selected customer computing system of the customer computing systems to, along with the first selected customer computing system, assist in testing the other of the customer computing systems.

9. A non-transitory computer-readable data storage medium storing a computer program executable by a factory computing system of a factory test infrastructure to perform a method comprising, for each customer computing system as a given customer computing system:
where the factory test infrastructure currently has available testing capacity, assigning the given customer computing system for testing within the factory test infrastructure prior to shipment of the given customer computing system to a customer in accordance with a customer order for the given customer computing system; and
upon testing of the given customer computing system reaching a stage at which the given customer computing system is itself able to perform computing system testing, where the factory test infrastructure no longer has available testing capacity, temporarily adding the given customer computing system to the factory test infrastructure to increase the available testing capacity of the factory test infrastructure.

10. The non-transitory computer-readable data storage medium of claim 9, wherein the factory test infrastructure comprises at least one test computing system including the factory computing system and any customer computing system that has been temporarily added to the factory test infrastructure,
and wherein assigning the given customer computing system for testing comprises assigning the given customer computing system to one of the at least one test computing system for actually performing testing of the given customer computing system.

11. The non-transitory computer-readable data storage medium of claim 10, wherein assigning the given customer computing system to one of the at least one test computing system comprises:
where the factory computing system has available testing capacity, assigning the given customer computing system to the factory computing system; and
where the factory computing system does not have available testing capacity, assigning the given customer computing system to a different one of the at least one test computing system that has available testing capacity.

12. The non-transitory computer-readable data storage medium of claim 9, wherein the method further comprises:
removing the given customer computing system from the factory test infrastructure upon satisfaction of any of a plurality of predetermined release conditions comprising:
a predetermined length of time having elapsed since the given customer computing system was temporarily added to the factory test infrastructure; and
the factory test infrastructure currently having excess available testing capacity.

13. The non-transitory computer-readable data storage medium of claim 12, wherein removing the given customer computing system from the factory test infrastructure comprises:
preventing the given customer computing system from being assigned any further customer computing systems for the given customer computing system to test;
upon the given customer computing system finishing testing of all customer computing systems that have been assigned to the given customer computing system to test:
causing testing of the given customer computing system itself to finish so that the given customer computing system can be shipped to the customer in accordance with the customer order; and
preventing the given customer computing system from being re-added to the factory test infrastructure.

14. A factory test infrastructure comprising:
a database to store test results for a plurality of customer computing systems tested within the factory test infrastructure; and
a factory computing system to temporarily include the customer computing systems within the factory test infrastructure to perform testing as available testing capacity of the factory test infrastructure becomes depleted.

15. The factory test infrastructure of claim 14, wherein the factory computing system is further to release the customer computing systems from the factory test infrastructure to perform testing as the available testing capacity of the factory test infrastructure is no longer depleted.
